(19) United States
(12) Patent Application Publication
(10) Pub. No.: US 2015/0048188 A1
(43) Pub. Date: Feb. 19, 2015

(54) PTO DRIVEN CHIPPER SYSTEM

(71) Applicant: Parker-Hannifin Corporation, Cleveland, OH (US)

(72) Inventor: Jarmo Harsia, Chicago, IL (US)

(21) Appl. No.: 13/967,934

(22) Filed: Aug. 15, 2013

(51) Int. Cl. F15B 11/17; A01G 3/00; B02C 18/24; B02C 25/00; B27L 11/00

(52) U.S. Cl. CPC F15B 11/17; B02C 25/00; B27L 11/00; B02C 18/24; A01G 3/002
USPC 241/101.75; 60/486

(57) ABSTRACT

A wood chipping system including a vehicle having an engine and a power take off attached to and selectively powered by the engine. A hydraulic pump is positioned on the vehicle and is driven by the power take off. The system can include a towable support having a chipper mounted thereon, the chipper having a chipper drum driven by a hydraulic motor, the hydraulic motor driving a hydraulic pump that drives a feed roll system of the chipper. The system can include a brake valve associated with the main motor to stop rotation of the chipper drum.

### TECHNICAL FIELD

The invention relates generally to wood chippers and in particular to a wood chipper that is operated using a power take off from the engine of a vehicle that tows the chipper.

### BACKGROUND

Typically, wood chippers include an engine for powering a chipper and a hydraulic system for rotating a feed wheel which feeds wood material and the like into the wood chipper where the material is cut by a cutting assembly housed within the chipper. The wood chipper is typically towed by a forestry bucket truck that is used to store and haul the wood chips. The truck has an engine and a hydraulic system for the bucket lift arm.

### SUMMARY

At least one embodiment of the invention provides a wood chipping system comprising: a vehicle having an engine; a power take off attached to the engine; a hydraulic pump positioned on the vehicle and driven by the power take off; a towable chipper having chipper drum driven by a hydraulic motor, the hydraulic motor driving a hydraulic pump positioned on the chipper and driving a feed roll system of the chipper; a hydraulic fluid supply line providing a supply of fluid from the vehicle to the chipper and a hydraulic fluid return line returning fluid from the chipper to the vehicle.

### BRIEF DESCRIPTION OF THE DRAWINGS

Embodiments of this invention will now be described in further detail with reference to the accompanying drawings, in which:

FIG. 1 is a block diagram of the wood chipping system of the present invention; and

FIG. 2 is a schematic view of a hydraulic circuit for a wood chipper and vehicle wherein the hydraulic power to operate the wood chipper is provided by a power take off attached to the vehicle.

### DETAILED DESCRIPTION OF THE DRAWING

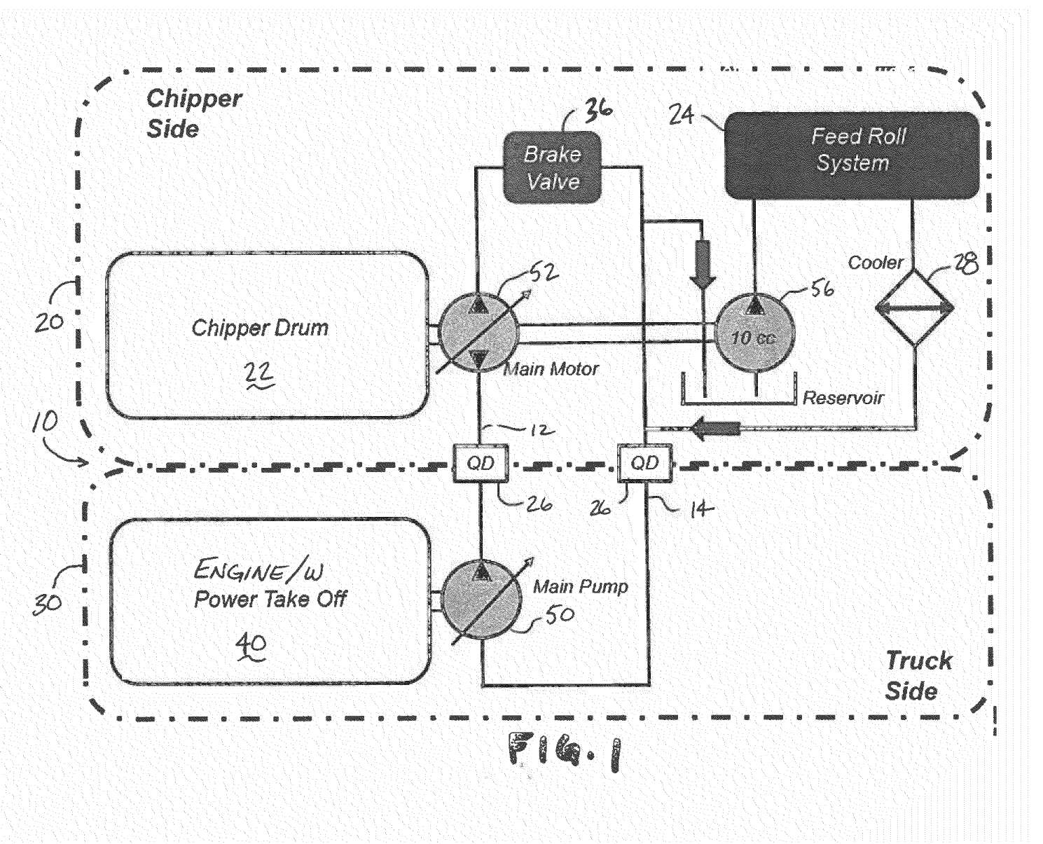

Referring to FIG. 1, a wood chipping system 10 is shown with a chipper represented by the broken line designated at 20 and a vehicle, typically a truck, represented by the broken line at 30. The vehicle 30 has an engine that includes a power take off attached to the engine and designated at 40. The system 10 further comprises a hydraulic pump 50 positioned on the vehicle 30 and driven by the power take off 40. The pump 50 supplies hydraulic fluid to a hydraulic motor 52 positioned on the chipper 20. The hydraulic motor 52 drives a chipper drum 22 and a hydraulic pump 56 which are both positioned on the chipper 20. The hydraulic pump 56 provides hydraulic power to a feed roll system 24 of the chipper 20. The system 10 includes a hydraulic fluid supply line 12 providing a supply of fluid from the vehicle 30 to the chipper 20 and a hydraulic fluid return line 14 returning fluid from the chipper 20 to the vehicle 30. The system 10 may include a cooler 28 such as shown in the hydraulic line leaving the feed roll system 24.

The chipper 20 may be in the form of a towable chipper that can be connected/disconnected from the vehicle 30. The supply line 12 and return line 24 include connectors 26 that enable the fluid lines of the vehicle and chipper to be disconnected from each other. The connectors 26 may be in the form of quick disconnect devices that are known in the art.

The system includes a brake valve 36 that can be used to stop fluid flow and prevent rotation of the chipper drum 22. The stopping of the drum 22 is significantly faster than existing engine based chippers.

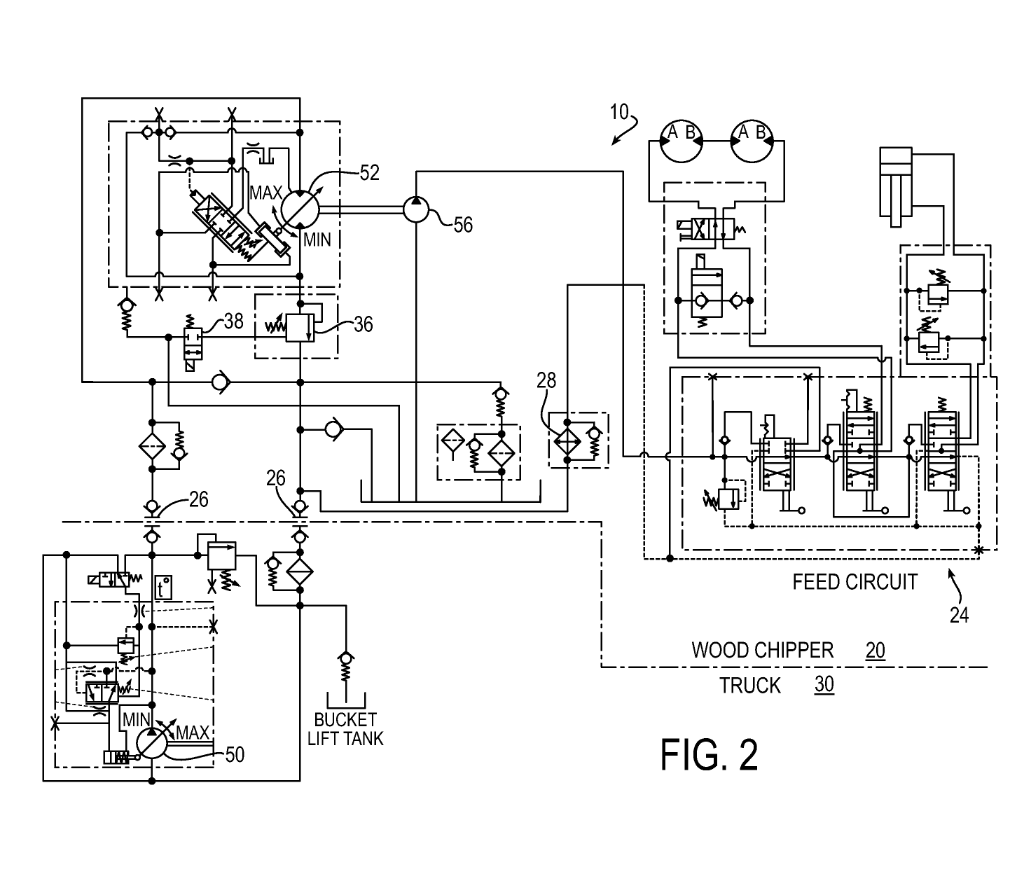

A hydraulic schematic of the system 10 shows additional detail of the brake valve 36 in FIG. 2. The brake valve 36, as shown, is a vented logic cartridge 36, downstream of the motor 52. The brake valve 36 is controlled by a normally closed solenoid valve 38. In normal operation the solenoid valve 38 is actuated, draining the vent of the logic cartridge 36, opening the logic cartridge 36 and thus allowing flow out of the motor 52 with little back pressure. When the chipper drum 22 needs to be stopped, the solenoid valve 38 de-energizes, the solenoid valve 38 returns to its spring held position closing the vent port and the logic cartridge 36 is now a high pressure relief valve. The back pressure on the motor 52 causes it to stop in a matter of seconds.

The chipper drum brake is engaged using a “panic” bar. Panic bars are used in chipper systems to stop the feed rollers. In the present invention, when the operator pushes the panic bar not only will the feed roller system stop, but the chipper drum 22 will also stop. The panic bar includes an input device, either a contact switch, a proximity switch, or some type of sensor or input that will provide a signal to the software once the operator pushes the panic bar. The input device provides a signal that the bar has been pushed, the software then commands to de-energize the solenoid valve 38 which closes the brake valve 36. The back pressure on the motor 52 causes the chipper drum 22 to stop in a matter of two to four seconds. It is also contemplated that a manual valve could be used in place of the solenoid valve 38 to engage the chipper drum brake.

Although the principles, embodiments and operation of the present invention have been described in detail herein, this is not to be construed as being limited to the particular illustrative forms disclosed. They will thus become apparent to those skilled in the art that various modifications of the embodiments herein can be made without departing from the spirit or scope of the invention.

1. A wood chipping system comprising:
a vehicle having an engine;
a power take off attached to and selectively powered by the engine;
a hydraulic pump positioned on the vehicle and driven by the power take off;
a towable support having a chipper mounted thereon, the chipper having a chipper drum driven by a hydraulic motor, the hydraulic motor driving a hydraulic pump positioned on the towable support, the hydraulic pump on the towable support driving a feed roll system of the chipper;
a hydraulic fluid supply line providing a supply of fluid from the vehicle to the hydraulic motor on the towable support and a hydraulic fluid return line returning fluid from the towable support to the vehicle; and
a brake valve associated with the main motor to stop rotation of the chipper drum.

3. The wood chipping system of claim 1 further comprising a pair of quick connect couplings fluidly connecting the vehicle to the towable support.

4. (canceled)

5. A system comprising a power take off for driving a first hydraulic pump to supply hydraulic fluid to a hydraulic motor via a hydraulic fluid supply line, the hydraulic motor driving a chipper drum and a second hydraulic pump that drives a feed roll system of a chipper, the hydraulic fluid returning to the first hydraulic pump via a hydraulic fluid return line; and a brake valve associated with the hydraulic motor for stopping rotation of the chipper drum.

6. (canceled)

7. The system of claim 5, wherein the brake valve is a vented logic cartridge downstream of the hydraulic motor.

8. The system of claim 5, further comprising an engine for powering the power take off, wherein the engine, the power take off and the first hydraulic pump are disposed on a vehicle.

9. The system of claim 8, wherein the hydraulic motor, the second hydraulic pump and the feed roll system are disposed on a towable support.

10. The system of claim 9, wherein the hydraulic fluid supply line includes a first quick connect coupler, and the hydraulic fluid return line includes a second quick connect coupler.

11. A chipper system comprising:
a hydraulic motor;
a chipper drum driven by the hydraulic motor;
a hydraulic pump driven by the hydraulic motor, the hydraulic pump providing hydraulic power to a feed roll system; and
a hydraulic circuit fluidly connecting the hydraulic motor to a source of hydraulic fluid power, the hydraulic circuit including a brake valve, the brake valve having a first and second position, the first brake valve position allowing fluid flow to the hydraulic motor, the second brake valve position stopping fluid flow to the hydraulic motor.

12. The system of claim 11, wherein the brake valve is moved to a second brake valve position when a panic bar is actuated.

13. The system of claim 11, wherein movement of the brake valve to the second brake valve position causes the chipper drum to stop rotating.

14. The system of claim 11, wherein movement of the brake valve to the second brake valve position causes the chipper drum to stop rotating in two to four seconds.

15. The system of claim 11, wherein movement of the brake valve to the second brake valve position causes the feed roll system to stop.

16. The system of claim 11, wherein the brake valve is a vented logic cartridge controlled by a solenoid valve.

17. The system of claim 16, wherein the brake valve is in the first brake valve position when the solenoid valve is open and the logic cartridge is in an open position.

18. The system of claim 16, wherein the brake valve is in the second brake valve position when the solenoid valve is closed and the logic cartridge is in a closed position.

19. The system of claim 17, wherein the logic cartridge is a high pressure relief valve when the logic cartridge is in a closed position.

20. The system of claim 11, wherein the hydraulic motor, the hydraulic pump and the feed roll system are disposed on a towable support, the system further comprising: a tow vehicle capable of towing the towable support; a power take off selectively driven by an engine of the tow vehicle; and a tow vehicle hydraulic pump supplying hydraulic fluid to the hydraulic motor on the towable support through the hydraulic circuit.
